(19) United States
(12) Patent Application Publication
(10) Pub. No.: US 2015/0048879 A1
(43) Pub. Date: Feb. 19, 2015

(54) BANDGAP REFERENCE VOLTAGE CIRCUIT AND ELECTRONIC APPARATUS THEREOF

(71) Applicant: ILI TECHNOLOGY CORP., HSINCHU COUNTY (TW)

(72) Inventors: BOU-CHING FUNG, HSINCHU CITY (TW); CHING-RONG CHANG, HSINCHU COUNTY (TW)

(73) Assignee: ILI TECHNOLOGY CORP., HSINCHU COUNTY (TW)

(21) Appl. No.: 14/133,574

(22) Filed: Dec. 18, 2013

(30) Foreign Application Priority Data
Aug. 14, 2013 (TW) 102129117

(51) Int. Cl. G05F 3/20

(52) U.S. Cl. CPC G05F 3/205
USPC 327/539

(57) ABSTRACT

A bandgap reference voltage circuit comprises a current mirror unit, an operation amplifier (OP), a first resistor, a second resistor, an auxiliary unit, and a voltage generation circuit. An output end of the OP is coupled to a feedback end of the current mirror unit. An end of the first resistor and an end of the second resistor are coupled to a positive input end of the OP. Another end of the first resistor is coupled to a second end of the current mirror unit. A second end of the voltage generation circuit is coupled to another end of the second resistor. An end of the auxiliary unit is coupled to a negative input end of the OP and a first end of the voltage generation circuit, and another end of the auxiliary unit is coupled to the first end of the current mirror unit.

### BACKGROUND

1. Field of the Invention

The present invention relates to a bandgap reference voltage circuit; in particular, to a bandgap reference voltage circuit for outputting a stable reference voltage and a device thereof.

2. Description of Related Art

In recent years, the internal circuit structure of the electric device becomes complicated with the technology growing. The internal circuit may include a number of the driving circuits and controlling circuits. However, the driving circuits and controlling circuits usually receive the mixed reference voltage as the operating power and maintain the normal operational state. Ideally, regardless of the input voltage changes slowly or suddenly, the reference voltage should be not affected by output current or temperature.

Actually, many projectors will use a bandgap reference voltage circuit to provide the reference voltage, and the bandgap reference voltage circuit uses the uniqueness of the base-emitter voltage of the transistors to reduce the influence of the output reference voltage with the different temperatures.

Please referring to FIG. 1, FIG. 1 shows a circuit diagram of a traditional bandgap reference voltage circuit. The bandgap reference voltage circuit 1 includes a current mirror unit 12, an operation amplifier OP, a voltage generation circuit 11, a first resistor R1, a second resistor R2, a power supply VDD, a ground GND and a reference voltage port VREF1. The current mirror unit 12 includes two P-MOS (P Metal-Oxides-Semiconductor) transistors 121, 122, and the voltage generation circuit 11 includes two BJTs (Bipolar Junction Transistor) 111, 112.

In FIG. 1, the BJTs 111, 112 of the voltage generation circuit 11 have the base-emitter voltages VBE1 and VBE2 respectively when the power supply VDD receives the stable direct current and the ground GND couples to the ground GND. The base-emitter voltages VBE1 and VBE2 let the current mirror unit 12 output a first current I1 and a second current I2, wherein the first current I1 and second current I2 appear a specific proportion relationship ideally. The specific proportion relationship relates to the size of the P-MOS transistors 121, 122. In more detail, the specific proportion relationship relates to the rate of channel width W and channel length L of the P-MOS transistors 121, 122.

Ideally, when the second current I2 flows through the first resistor R1, the second resistor R2 and the BJT 112 of the voltage generation circuit 11, the reference voltage port VREF1 generates a voltage, which isn't affected by the temperature change. But in the practical situation, the reference voltage port VREF1 is easily affected by an output parasitic capacitor 15 and lets the reference voltage unstable. Therefore, if the driving circuit or controlling circuit don't have the fixed reference voltage to maintain operation normally, it may cause error or make harm to the electric device.

### SUMMARY

The object of the present invention is to provide a bandgap reference voltage circuit. The bandgap reference voltage circuit comprises a current mirror unit, an operation amplifier (OP), a first resistor, a second resistor, an auxiliary unit, and a voltage generation circuit. An output end of the OP is coupled to a feedback end of the current mirror unit. An end of the first resistor is coupled to a positive input end of the OP, another end of the first resistor is coupled to a second end of the current mirror unit. An end of the second resistor is coupled to a positive input end of the OP. A second end of the voltage generation circuit is coupled to the other end of the second resistor. An end of the auxiliary unit is coupled to a negative input end of the OP and a first end of the voltage generation circuit, and another end of the auxiliary unit is coupled to the first end of the current mirror unit. The bandgap reference voltage circuit outputs a reference voltage at another end of the auxiliary unit.

An embodiment of the present invention provides an electric device, comprising the bandgap reference voltage circuit abovementioned and a functional circuit, wherein the functional circuit is coupled to the bandgap reference voltage circuit and the bandgap reference voltage circuit provides a reference voltage to the functional circuit.

In summary, the bandgap reference voltage circuit of the present invention moves out the reference voltage port from the negative feedback loop, so it may avoid the output parasitic capacitor is too large and the negative feedback loop is damaged, and further avoid the reference voltage, which is provided by itself decreases stability.

In order to further the understanding regarding the present invention, the following embodiments are provided along with illustrations to facilitate the disclosure of the present invention.

### BRIEF DESCRIPTION OF THE DRAWINGS

FIG. 1 shows a circuit diagram of a traditional bandgap reference voltage circuit;

FIG. 2 shows a circuit diagram of a bandgap reference voltage circuit according to an embodiment of the present invention;

FIG. 3A shows curve diagram of base-emitter voltages of the BJTs with the temperature in a voltage generation circuit according to an embodiment of the present invention;

FIG. 3B shows curve diagram of a base-emitter voltage difference between the BJTs with the temperature and the base-emitter voltage difference multiply to resistance rate with temperature according to an embodiment of the present invention;

FIG. 3C shows curve diagram of a reference voltage with the temperature at a reference voltage port in a bandgap reference voltage circuit according to an embodiment of the present invention;

FIG. 4 shows block diagram of an electric device according to an embodiment of the present invention.

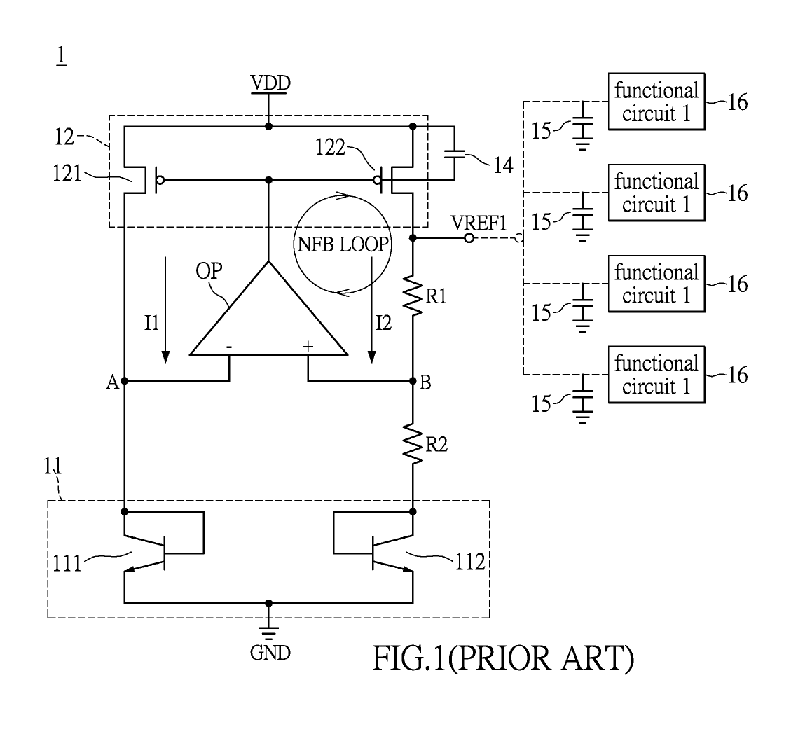

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

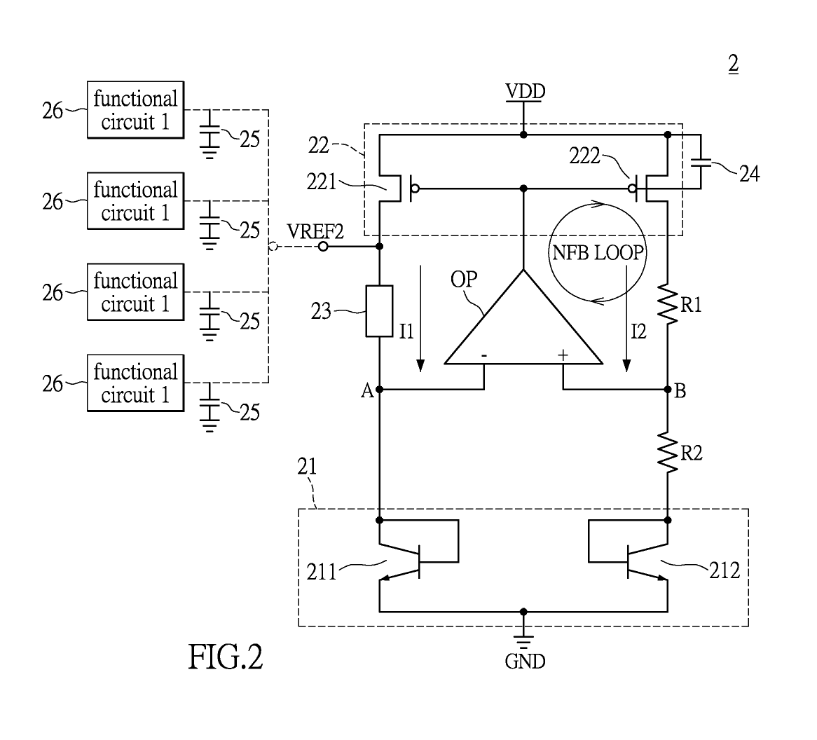

Please referring to FIG. 2, FIG. 2 shows a circuit diagram of a bandgap reference voltage circuit according to an embodiment of the present invention. A bandgap reference voltage circuit 2 comprises a current mirror unit 22, an operation amplifier OP, a voltage generation circuit 21, a first resistor R1, a second resistor R2, an auxiliary unit 23, a power supply VDD, ground GND and an output reference voltage port VREF2. An output end of the operation amplifier OP is coupled to a feedback end of the current mirror unit 22. An end of the first resistor R1 is coupled to a positive input end of the operation amplifier OP through the point B, another end of the first resistor R1 is coupled to a second end of the current mirror unit 22. An end of the second resistor R2 is coupled to a positive input end of the operation amplifier OP. A second end of the voltage generation circuit 21 is coupled to another end of the second resistor R2. An end of the auxiliary unit 23 is coupled through the point A to a negative input end of the operation amplifier OP and a first end of the voltage generation circuit 21, and another end of the auxiliary unit 23 is coupled to the first end of the current mirror unit 22.

In this embodiment of the present invention, the power supply VDD is used to receive the stable direct current power. The current mirror unit 22 includes a plurality of transistors 221 and 222, wherein the sources of the transistors 221 and 222 are coupled to the power supply VDD. The gates of the transistors 221 and 222 (i.e. the feedback end of the current mirror unit 22) are coupled to the output end of the operation amplifier OP. The drains of the transistors 221 and 222 are coupled to the end of the auxiliary unit 23 and another end of the first resistor R1 respectively.

According to the circuit feature of the current mirror, the first end and the second end of the current mirror unit 22 output a first current I1 and a second current I2, wherein the first current I1 and the second current I2 appear a specific proportion relationship ideally. The specific proportion relationship relates to the size of the P-MOS transistors 221, 222 (the rate of channel width W and length L, W/L). In this embodiment of the present invention, the transistors 221, 222 may be as the P-MOS, further as P-MOSFET (Metal-Oxides-Semiconductor Field-Effect Transistor, MOSFET) or thin-film transistor. In short, the transistors 221, 222 of the present invention aren't limited thereto.

The voltage generation circuit 21 includes the BJTs 211 and 212. The collector of the BJT 211 is coupled to the base of the BJT 211, and the collector of the BJT 211 (i.e. the first end of the voltage generation circuit 21) is coupled through the point A to the negative input end of the operation amplifier OP and another end of the auxiliary unit 23. The collector of the BJT 212 is coupled to the base of the BJT 212, the collector of the BJT 212 (i.e. the second end of the voltage generation circuit 21) is coupled to the second resistor R2, and the collector of the BJT 212 is also coupled through the point B to the positive input end of the operation amplifier OP and the first resistor R1. The emitters of the BJTs 211 and 212 are coupled to ground GND. According to the abovementioned coupling, the circuit feature of the BJTs 211 and 212 resemble to the diode. It's worth noting that the present invention is illustrated by the NPN-type BJT, it also may be replaced by the PNP-type BJT actually. Furthermore, the voltage generation circuit 21 isn't necessary achieved by the BJTs 211, 212, the BJTs 211, 212 must be replaced by the transistor, whose the crossing-voltage between both ends is a temperature coefficient.

In the embodiment of the present invention, the BJTs 211 and 212 of the voltage generation circuit 21 have the base-emitter voltage VBE1 and VBE2 respectively. Under the situation that the negative feedback path NFB LOOP existing, the voltage on the positive input end and the negative input end of the operation amplifier OP are equal, that is the point A and B must be the same. Therefore, the base-emitter voltage VBE1 equals to that the crossing-voltage of the second resistor R2 affiliates the base-emitter voltage VBE2.

The base-emitter voltages VBE1 and VBE2 are related with temperature, and it may define a voltage difference VPTAT related with the temperature for that the base-emitter voltage VBE1 subtracts the base-emitter voltage VBE2, that is the voltage difference VPTAT relates with temperature of the crossing-voltage on the second resistor R2. Due to the collector currents on the BJTs 211 and 212 will increase with the raised temperature (i.e. the drain currents has the positive temperature coefficient), so it could compensate that the value of the base-emitter voltages VBE1 of the BJT 211 and the value of the base-emitter voltage VBE2 of the BJT 212 are decreased with the raised temperature (i.e. the base-emitter voltages VBE1 and VBE2 have the negative temperature coefficient). Then, maintaining the voltage of the reference voltage port VREF2 unchanged.

The auxiliary unit 23 is an electrical unit, which has impedance unrelated to the frequency. In the embodiment of the present invention, the auxiliary unit 23 may be a resistor, but the present invention isn't limited thereto. If the resistivity of the auxiliary unit 23 equals to the resistivity of first resistor R1 and the first current I1 equals to the second current I2, the reference voltage on the reference voltage port VREF2 is that the base-emitter voltage adds the voltage difference VPTAT of the resistance rate. The resistance rate is the first resistor R1 dividing by the second resistor R2.

Since the reference voltage port VREF2 isn't sited on the negative feedback loop NFB LOOP which is formed by the transistor 222, the operation amplifier OP and the first resistor R1, the stability of the reference voltage port VREF2 isn't affected by that the value of output parasitic capacitor 25 is excessive large. In other words, due to the auxiliary unit 23 of the embodiment isn't affected by the frequency, the reference voltage on the reference voltage port VREF2 isn't affected by the output parasitic capacitor 25 and maintains the stable output. Furthermore, the reference voltage on the reference voltage port VREF2 also wouldn't be affected by the temperature through that the auxiliary unit 23, the first resistor R1 and the second resistor R2 are sited. In addition, the output reference voltage may be stable by the function of the auxiliary unit 23, so when the value of the first resistor R1 equals to the resistivity of the auxiliary unit 23 and the first current I1 equals to the second current I2, the voltages on the drains of the transistor 221 and 222 will be equal and decrease the effect of the channel-length modulation.

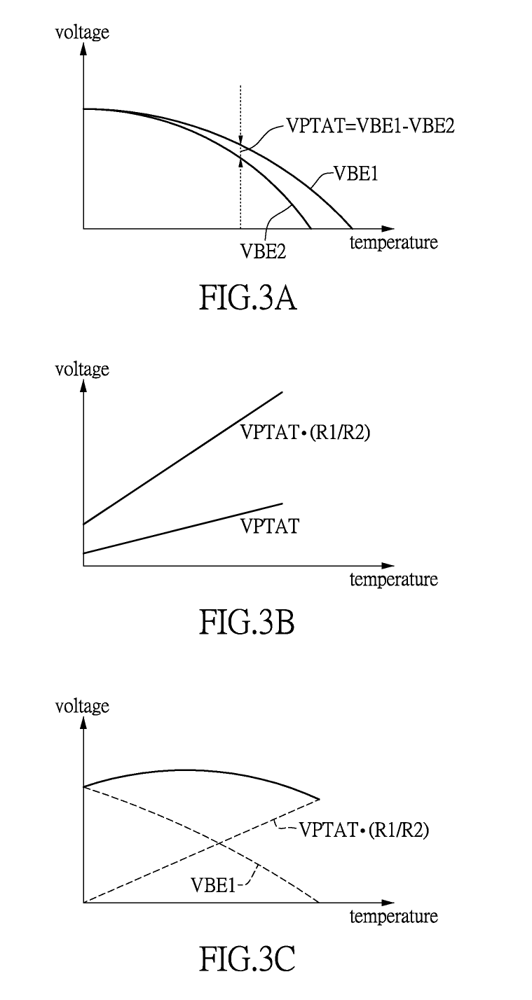

Next, it will illustrate the reason that the reference voltage maintains stability effects without the temperature. Please referring to FIG. 3A˜3C, FIG. 3A shows curve diagram of base-emitter voltages of the BJTs with the temperature in a voltage generation circuit according to an embodiment of the present invention, FIG. 3B shows curve diagram of a base-emitter voltage difference between the BJTs with the temperature and the base-emitter voltage difference multiply to resistance rate with temperature according to an embodiment of the present invention, and FIG. 3C shows curve diagram of a reference voltage with the temperature at a reference voltage port in a bandgap reference voltage circuit according to an embodiment of the present invention.

In FIG. 3A, it shows the base-emitter voltage VBE1 of the BJT 211 and the base-emitter voltage VBE2 of the BJT 212 going down with the temperature rising. In other words, the base-emitter voltage VBE1 of the BJT 211 and the base-emitter voltage VBE2 of the BJT 212 have the negative temperature coefficient. Therefore, FIG. 3A and FIG. 3B show that the spacing of the voltage difference VPTAT is wider by the temperature rising. It means that the voltage difference VPTAT has the direct ratio with the temperature and has the positive temperature coefficient.

Please referring to FIG. 2 and FIG. 3, as follow as the above mention, the voltage difference VPTAT equals to the crossing-voltage of the second resistor R2. Therefore, the first current I1 is the voltage difference dividing by the second resistor R2, that is I1=VPTAT/R2. If the first current I1 and the second current I2 are equal, and the resistivity of the auxiliary unit 23 equals to the resistivity of the first resistor R1, the auxiliary unit 23 equals to crossing-voltage of the first resistor R1. The auxiliary unit 23 and the crossing-voltage of the first R1 are the voltage ratio, which is the voltage difference VPTAT multiples to the resistance ratio, wherein the resistance ratio is the first resistor R1 divides by the resistor R2.

Then, please referring to FIG. 2 and FIG. 3C, the reference voltage of the voltage reference port VREF2 equals to the base-emitter voltage VBE1 and the voltage difference VPTAT of the resistance ratio. In the FIG. 3, shows that it maintains stability effects without the temperature.

It's worth noting that although the embodiment illustrates that the first current I1 and the second current I2 are equal, and the resistivity of the auxiliary unit 23 equals to the first resistor R1, but it isn't limited thereto. Please referring to FIG. 2, actually, the reference voltage of the reference voltage port VREF2 equals to that the first current I1 multiples the specific ratio and the resistivity of the auxiliary unit 23, that is VPTAT·(Z23/R2), wherein the Z23 represents the resistivity of the auxiliary unit 23.

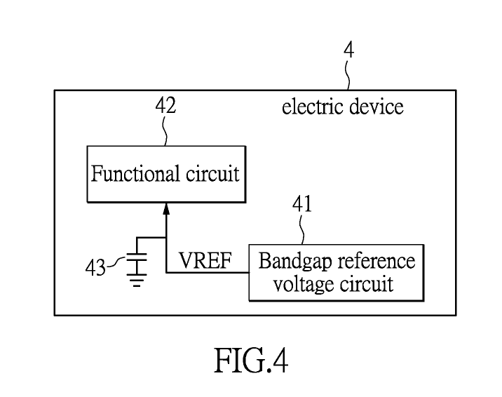

Please referring to FIG. 4, FIG. 4 shows block diagram of an electric device according to an embodiment of the present invention. The electric device 4 comprises the bandgap reference voltage circuit 41 abovementioned and a functional circuit 42, wherein the functional circuit 42 is coupled to the bandgap reference voltage circuit 41. The bandgap reference voltage circuit 41 avoids the reference voltage VREF is affected by the output parasitic capacitor 43, and provides a stable reference voltage to the functional circuit 42 for operating stably.

In summary, the bandgap reference voltage circuit of the present invention moves out the reference voltage port from the negative feedback loop, so it may avoid that the output parasitic capacitor is too large and the negative feedback loop is damaged, and further avoid the reference voltage which is provided by itself decreases stability. In addition, the bandgap reference voltage extra sites the auxiliary unit to avoid the stability of the reference voltage. The auxiliary unit is the impedance affected without the frequency. Apart from this, due to the effect of the auxiliary unit, the output reference voltage will maintain stably. When the resistivity of the first resistor equals to the resistivity of the auxiliary unit, the voltages on the drains of the transistors will be equal and decrease the effect of the channel-length modulation. According to reports, the electric device uses the bandgap reference voltage circuit receiving the stable reference voltage which is provided by the bandgap reference voltage to maintain the operating normally.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A bandgap reference voltage circuit comprising:
a current mirror unit, having a first end, a second end and a feedback end;
an operation amplifier, having a positive input end, a negative input end and a output end, the output end of the operation amplifier coupled to the feedback end of the current mirror unit;
a first resistor, an end of the first resistor coupled to the positive input end of the operation amplifier, another end of the first resistor coupled to the second end of the current mirror unit;
a second resistor, an end of the second resistor coupled to positive input end of the operation amplifier;
a voltage generation circuit, having a first end and a second end, the second end of the voltage generation circuit coupled to another end of the second resistor; and
an auxiliary unit, an end of the auxiliary unit coupled to the negative input end of the operation amplifier and the first end of the voltage generation circuit, another end of the auxiliary unit coupled to the first end of the current mirror unit;
wherein the bandgap reference voltage circuit outputs a reference voltage at another end of the auxiliary unit.

2. The bandgap reference voltage circuit according to claim 1, wherein the auxiliary unit has the impedance unrelated to the frequency.

3. The bandgap reference voltage circuit according to claim 1, wherein the current mirror unit comprises:
a first P-MOS transistor; and
a second P-MOS transistor;
wherein the first P-MOS transistor and second P-MOS transistor are coupled to a power supply, the gates of the first P-MOS transistor and second P-MOS transistor are coupled to the output end of the operation amplifier, and the drains of the first P-MOS transistor and second P-MOS transistor are coupled to another end of the auxiliary unit and the another end of the first resistor respectively.

4. The bandgap reference voltage circuit according to claim 2, wherein the auxiliary unit is a resistor.

5. The bandgap reference voltage circuit according to claim 1, wherein the voltage generation circuit comprises:
a first bipolar junction transistor; and
a second bipolar junction transistor;
wherein the bases of the first bipolar junction transistor and second bipolar junction transistor are coupled to the collectors of the first bipolar transistor and second bipolar transistor respectively, the emitters of the first bipolar junction transistor and second bipolar junction transistor are coupled to a ground, the collector of the first bipolar junction transistor is coupled to the negative input end of the operation amplifier and another end of the auxiliary unit, and the collector of the second bipolar junction transistor is coupled to another end of the second resistor.

6. An electric device, comprising:
a functional circuit; and
a bandgap reference voltage circuit, coupled to the functional circuit, the bandgap reference voltage circuit providing a reference voltage to the functional circuit, comprising:
a current mirror unit, having a first end, a second end and a feedback end;
an operation amplifier, having a positive input end, a negative input end and an output end, the output end of the operation amplifier coupled to the feedback end of the current mirror unit;
a first resistor, an end of the first resistor coupled to the positive input end of the operation amplifier, another end of the first resistor coupled to the second end of the current mirror unit;
a second resistor, an end of the second resistor coupled to positive input end of the operation amplifier;
a voltage generation circuit, having a first end and a second end, the second end of the voltage generation circuit coupled to another end of the second resistor; and
an auxiliary unit, an end of the auxiliary unit coupled to the negative input end of the operation amplifier and the first end of the voltage generation circuit, another end of the auxiliary unit coupled to the first end of the current mirror unit;
wherein the bandgap reference voltage circuit outputs a reference voltage at another end of the auxiliary unit.

7. The bandgap reference voltage circuit according to claim 6, wherein the auxiliary unit has impedance unrelated to the frequency.

8. The bandgap reference voltage circuit according to claim 6, wherein the current mirror unit comprises:
a first P-MOS transistor; and
a second P-MOS transistor;
wherein the first P-MOS transistor and second P-MOS transistor are coupled to a power supply, the gates of the first P-MOS transistor and second P-MOS transistor are coupled to the output end of the operation amplifier, and the drains of the first P-MOS transistor and second P-MOS transistor are coupled to another end of the auxiliary unit and the another end of the first resistor respectively.

9. The bandgap reference voltage circuit according to claim 7, wherein the auxiliary unit is a resistor.

10. The bandgap reference voltage circuit according to claim 6, wherein the voltage generation circuit comprises:
a first bipolar junction transistor; and
a second bipolar junction transistor;
wherein the bases of the first bipolar junction transistor and second bipolar junction transistor are coupled to the collectors of the first bipolar transistor and second bipolar transistor respectively, the emitters of the first bipolar junction transistor and second bipolar junction transistor are coupled to a ground, the collector of the first bipolar junction transistor is coupled to the negative input end of the operation amplifier and another end of the auxiliary unit, and the collector of the second bipolar junction transistor is coupled to another end of the second resistor.
